(19) United States
(12) Patent Application Publication
(10) Pub. No.: US 2003/0182559 A1
(43) Pub. Date: Sep. 25, 2003

(54) Secure communication apparatus and method for facilitating recipient and sender activity delegation

(76) Inventors: Ian Curry, Kanata (CA); Blake Sutherland, Stittsville (CA); Kevin Simzer, Gloucester (CA)

Correspondence Address: VEDDER PRICE KAUFMAN & KAMMHOLZ, 222 N. LASALLE STREET, CHICAGO, IL, 60601, US

(21) Appl. No.: 10/105,046

(22) Filed: Mar. 22, 2002

(51) Int. Cl. H04L 9/32

(52) U.S. Cl. 713/189; 713/201

(57) ABSTRACT

A method and apparatus, such as a secure distribution server, receives encrypted information from a sender, wherein the encrypted information is for transmission to a plurality of intended recipients. In addition to the encrypted information, the method includes receiving an encrypted secret key that is encrypted using a public key associated with the secure distribution server. The method and apparatus decrypts the encrypted secret key to produce a decrypted secret key. The method and apparatus then obtains a public key associated with one or more delegates of the intended recipient(s), sender(s) or other entity and encrypts the decrypted secret key with the corresponding public key of at least one delegate (or each of a plurality of delegates) associated with the intended recipient(s) or sender(s) to produce at least one delegate-specific secure secret key (or plurality of delegate-specific secure secret keys). The method and apparatus then forwards the received encrypted information sent by the sender and also sends at least one delegate-specific secure secret key to a corresponding delegate of the intended recipient(s) or sender(s).

### BACKGROUND OF THE INVENTION

The invention relates generally to secure communication systems and methods and more particularly to secure communication systems and methods employing secure network elements such as servers.

Secure information systems are known which employ, for example, secure e-mail servers. For example, public key-based encryption systems may employ a secure server that performs the encryption of information, such as encrypting an e-mail or other collection of information after it is received by a sending unit, such as a wireless or non-wireless PDA, internet appliance, telephone, laptop computer, desktop computer or any other mobile or non-mobile device. In such systems, the secure server encrypts the information using a secret key, such as a symmetric key generated by the secure server. In order to decrypt the document, an intended recipient also needs the secret key. Therefore, the secure server retrieves a public key of an encryption key pair associated with the intended recipient and encrypts the secret key with the public key of the recipient and forwards the encrypted information and the encrypted secret key to the recipient on behalf of the sender. However, with such systems, the secure server typically must encrypt the information. This can result in an insecure system since the information desired to be encrypted is encrypted only after it is sent to the server. Alternatively, in other prior art systems, the message information is encrypted by the sender, and then decrypted by the server and re-encrypted by the server for transmission to the intended recipients. Requiring the server to perform the bulk encryption of the message information adds additional processing requirements on the server.

In yet another type of secure information system, a sending unit retains the public key certificates of each of the intended recipients in a local cache or obtains them from a lightweight directory access protocol (LDAP) server, from a public key certificate directory such as an X.500 type directory, or other suitable certificate source. Obtaining each of the recipient public key certificates by the sending unit can require significant complexity and significant processing capabilities. For example, where a sending unit (sender) wishes to send a large message having many recipients, the public key for each of the recipients must be located by some manner. This can require many time consuming retrievals by the sending unit. Moreover, this is typically done on a real time basis with larger messages thus requiring the sender to perform the encryption during an on line session. The overhead and processing requirements can be burdensome and significantly reduce the performance of certain types of senders such as hand held devices, for example, that typically have limited amounts of processing capability and limited bandwidth connections to a network.

Moreover, for personal trust relationships, such as those where the sender and recipient are not in the same community of trust, meaning that they do not share the same certificate authority (CA), or belong to certificate authorities that are cross certified as trusting one another or that do not share a common root certificate of a trust authority embedded in a browser or other suitable application, the sender and recipient need to make a trust decision through another mechanism such as the sender or recipient choosing to trust the public key certificate. A problem with personal trust relationships is that sending units must typically manage them themselves and there is no easy way to readily share external user's certificates across a broad set of internal sending units. A difficulty is that external user certificates cannot be validated using CA signatures because the certificate is not cross certified to the internal sending unit's CA (or user's CA). When there is no ability to verify the signature on a certificate and hence the trust decision is made through another mechanism (such as the sender or recipient choosing to trust the certificate), user devices generally store the public key certificates locally (as opposed to in a public directory).

Also, it would be desirable to improve deployment capabilities in systems that have many sending units. For example, having smaller sending unit cryptographic software modules to enable suitable secure information sessions would be desirable.

A secure information system requires the sender to encrypt a document or other information using a secret key and then the sender contact the secure server to have the secure server obtain a public key associated with an intended recipient. The secure server retrieves the public key in real time from a certificate authority and transmits the public key back to the sender. The sender encrypts the secret key with the public key and transmits the encrypted document and the encrypted secret key to the secure server for transmission to the recipient. However, such a system requires dialog back and forth between the sending unit and the secure server and the sending of the public keys back during an on line connection when the document is being encrypted. Therefore, off line secure communication is not readily facilitated. For example, where the sending unit is a portable unit and the user is not connected with the secure server (for example, while the user is in an aircraft), it would be desirable to allow the sending unit to perform at least portions of the encryption process. In addition, such systems require the sending unit to encrypt a copy of the symmetric key for each of the intended recipients. Since a sending device does not have access to the network while in offline mode, the symmetric key will have to be encrypted with a public key that is stored on the device. Typically this is accomplished by having the sending device cache the public key certificates of potential intended recipients. In the case of handheld devices, the caching utilizes valuable storage that is often in short supply. Where there is a long distribution list for a message, for example, many recipients may be listed, this can require the sending unit, such as a small hand held device or other unit, to perform large amounts of processing and require large amounts of storage for the generation of the encrypted keys for each of the recipients.

Also, another known technique employs SSL (or other transport layer security schemes) to deliver sensitive email from a sender initially to a server. The sender typically authenticates to the server using a password and sends a message over the secure transport to a server. The server then sends an insecure notification email to one or more recipients, informing them that a message is available at the server. A recipient then supplies a password and downloads the message from the server, again using SSL or other secure transport for security. This scheme has the advantage that only browser software is required to send or receive email. However, the messages are typically only secured in transit. If the recipient retains a copy of the message, this scheme does not add security for the message copy. Similarly, if a message is composed offline pending a network connection, the sender holds an insecure copy of the message.

Email programs and other programs are known that allow a user to delegate another user as an acceptable recipient of email messages. Accordingly, a delegate may be a software application or device that has the privilege of reading a recipient's messages and may be granted that privilege by the recipient or an administrator of a network. In the case of surveillance-type delegation, an organization may be interested in checking the information received by an individual without their knowledge. Hence, the administrator may set up an administrator's computer as being an authorized delegate that may decrypt messages sent to or by the recipient without the recipient's knowledge. Setting up the delegate is typically done through a user interface. A problem arises in secure messaging environments with delegates since a sender typically does not have an effective mechanism to encrypt for a designated delegate of a recipient since the sender is typically unaware of any delegation privileges. Similarly, with surveillance delegation, senders typically do not know or cannot determine who the delegate is for a recipient and cannot encrypt for the surveillance delegate and therefore the delegate may be unable to read encrypted messages sent to the recipient.

Delegation may be applied to the receipt of encrypted of messages and the decryption of information for purposes of reading encrypted messages by a delegate. In addition, it would be desirable to allow a delegate to digitally sign on behalf of a delegator. However, typically such systems require the sharing of private signing keys.

Accordingly, it would be desirable to have methods and apparatus that remove or reduce the complexity for secure information communications and provide end to end security for delegated information. It would also be desirable to better facilitate delegation activities, such as receiving encrypted messages, encrypting on behalf of a delegator, or digitally signing information on behalf of a delegator.

### BRIEF DESCRIPTION OF THE DRAWINGS

The present invention is illustrated by way of example and not limitation in the accompanying figures, in which like references indicate similar elements, and in which:

FIG. 1 is a block diagram illustrating one example of a secure communication system in accordance with one embodiment of the invention;

FIG. 2 is a flow chart illustrating one example of a method for securing information in accordance with one embodiment of the invention;

FIG. 3 is a flow chart illustrating one example of a method for securing information in accordance with one embodiment of the invention;

FIG. 4 is a flow chart illustrating one example of a method for securing information in accordance with one embodiment of the invention;

FIG. 5 is a block diagram illustrating one example of a secure communication system in accordance with one embodiment of the invention;

FIG. 6 is a flow chart illustrating one example of a method for securing information in accordance with one embodiment of the invention;

FIG. 7 is a flow chart illustrating one example of a method for securing information in accordance with one embodiment of the invention; and

FIG. 8 is a flow chart illustrating one method of providing digital signature delegation in accordance with one embodiment of the invention.

### DETAILED DESCRIPTION OF THE PREFERRED EMBODIMENT

Briefly, a method and apparatus, such as a secure distribution server (SDS), receives encrypted information from a sender, wherein the encrypted information is for transmission to at least one intended recipient. In addition to the encrypted information, the method includes receiving an encrypted secret key that is encrypted using a public key associated with the secure distribution server. The method and apparatus decrypts the encrypted secret key to produce a decrypted secret key. The method and apparatus then obtains a public key associated with one or more delegates of the intended recipient and encrypts the decrypted secret key with the corresponding public key of the at least one delegate (or each of a plurality of delegates) associated with the intended recipient(s) to produce at least one delegate-specific secure secret key (or plurality of delegate-specific secure secret keys. The method and apparatus then forwards the received encrypted information sent by the sender and also sends the at least one delegate-specific secure secret key to a corresponding delegate of the intended recipient and if desired sends the encrypted information and a recipient-specific secret key to the intended recipient.

For example, the method and apparatus, receives encrypted information from a sender wherein the encrypted information is for transmission to one or a plurality of intended recipients. The method and apparatus obtains corresponding public keys associated with at least one (or if desired, each) of the plurality of intended recipients (including using a same public key for a group of intended recipients) and then encrypts the decrypted secret key with the corresponding public key of at least one of the plurality of intended recipients to produce at least one recipient-specific secure secret key. Stated another way, the method and apparatus also encrypts the decrypted secret key for one or more intended recipients, in addition to encrypting the secret keys for any detected delegates, and uses a corresponding public key to produce one or more recipient-specific secure secret keys in addition to delegate-specific secret keys. The method and apparatus then forwards the received encrypted information sent by the sender and also sends at least one recipient-specific secure secret key to a corresponding intended recipient and the delegate-specific secure secret key(s) to a delegate(s) of each intended recipient.

As such, the information is encrypted before sending to the apparatus, such as a network element serving as a secure distribution server, and the secure distribution server maintains the information in encrypted form and forwards it to an intended recipient and/or delegate but only after encrypting the secret key for each intended recipient and/or delegate. Therefore, the sending unit need not perform the encryption of the secret key for many recipients or delegates, thereby improving the performance of the sending unit, reducing the amount of information that needs to be transmitted to the network, and allowing the information to be encrypted throughout the process. In addition, the information may be encrypted off line without the requirement for the caching of large numbers of intended recipient certificates and subsequently sent in encrypted form in an online session to the secure distribution server thereby facilitating an off line encryption process by the sending unit to provide additional flexibility. Other advantages will be recognized by those of ordinary skill in the art.

In addition, if desired, an apparatus, such as a sender, encrypts secret keys using a public key or public keys associated with each of a plurality of additional secure distribution servers, where multiple secure distribution servers are employed. Each SDS may have its own public key pair or multiple SDS's may share a key pair. The method and apparatus can also encrypt the secret key using a public key associated with any intended server (e.g., timestamp server or content scanner) or other entity. If desired, the sending unit may also apply a digital signature to the information. The secure distribution server may generate the encryption key pairs, such as a public encryption key and private decryption key on behalf of a recipient if desired. In an alternative embodiment, the method and apparatus may generate a copy of the decrypted secret key for each of the plurality of intended recipients and encrypt the copies of the decrypted secret keys with corresponding public keys associated with intended recipients.

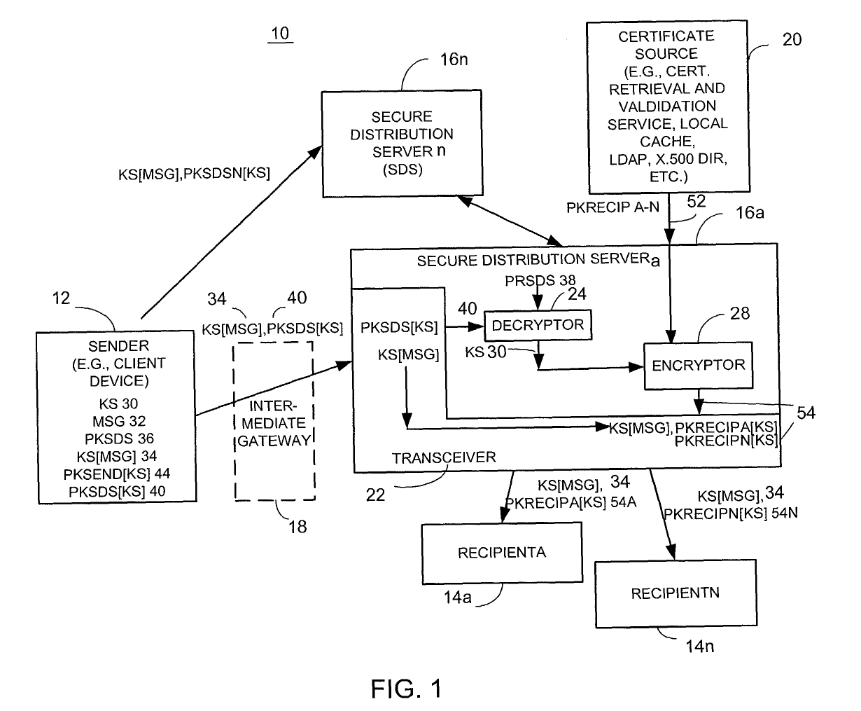

FIG. 1 illustrates one example of a secure information system 10 that employs a sender 12 that sends encrypted information to one or more intended recipients 14a-14n through one or more network elements 16a-16n, such as secure distribution servers. The sender 12 may communicate with the network elements 16a-16n through an intermediate gateway 18. For example, where the information is e-mail, the intermediate gateway 18 may be an e-mail server and the network element 16a may be a Web service that is carried out by one or more servers that are in operative communication through the Internet or other suitable LAN or WAN. Alternatively, the network elements 16a-16n may be in an intranet. As used herein, the term “information” includes any information desired to be encrypted which may include, but is not limited to, e-mails, audio data, video data, documents such as HTML, PDF or any other information in any suitable format, data bases, or any contiguous collection of data, for example, any suitable information transported over any information transport protocol or any other suitable information.

The secure communication system 10 also includes a public key certificate source 20 such as a local cache of the network element 16a, an LDAP server, one or more X.500 directories, a certificate retrieval and validation service, such as a Web service, or any other source of public key certificates required by the network element 16a.

For purposes of illustration only, and not limitation, the invention will be described with reference to securing e-mail. However, it will be recognized that the invention is equally applicable to any other suitable information format and information transport protocol. The network element 16a includes a transceiver 22, a decryptor 24, and an encryptor 28. The network element 16a may be implemented as a server suitably coupled to one or more wide area networks or local area networks as desired. The transceiver 22 may be any suitable circuitry, such as hardware, software, firmware or any suitable combination thereof, that facilitates the receiving and sending of information to and from a sender and other entities. The network element 16a includes one or more processing devices, such as DSPs, microprocessors, microcomputers, ASIC's or any other suitable processing devices operably coupled to memory, such as RAM, ROM, distributed memory, registers, or any other suitable memory that in one embodiment contains executable instructions that when read by the one or more processing devices, causes the one or more processing devices to carry out the operations described herein. By way of example and not limitation, the decryptor 24 and the encryptor 28 are software modules that are executed by the network element. It will be recognized that these functions may be distributed to other network elements or any other entities as desired. In an alternative embodiment, the decryptor and encryptor may be discrete logic or any suitable combination of hardware, firmware and software and may include also, for example, state machines or any other suitable hardware, firmware or software combination as desired.

The sender 12 includes a suitable cryptographic engine to at least carry out conventional symmetric and asymmetric encryption and decryption. Likewise, each of the recipients include a cryptographic engine that carries out at least the decryption operation to suitably decrypt the encrypted information encrypted by the sender 12 and to decrypt the encrypted secret key. The recipient may also forward the decrypted information to a time stamper or may pass the decrypted information to a content scanner to detect desired content (e.g., virus', word searches etc.).

Alternatively, the SDS may contain the time stamper and/or content scanner and decrypts the encrypted information using the decrypted secret key before passing the decrypted information to the content scanner. Also, the SDS may encrypt the decrypted secret key using a public key associated with at least one of: a time stamp device and a content scanning device. The SDS may send the encrypted information and the encrypted secret key to at least one of the devices. The devices perform time stamping and/or content scanning on decrypted information and send a result back to the SDS. In the case of time stamping the encrypted information may be time stamped or decrypted information may be time stamped. The time stamp may be returned to the SDS. In the case of the content scanning, the SDS receives back from the content scanning device, the result of the scan, e.g., whether scanning detected a virus or whether the encrypted information can be forward to the intended recipient since no virus was detected, and forwards the encrypted information with the recipient-specific encrypted secret key to an intended recipient. If the content scanning device determines that there is a virus or other reason for not sending the encrypted information to an intended recipient, the content scanning device sends a message to the SDS indicating the same and the SDS notifies the sender or a third party that the encrypted information failed the content scan.

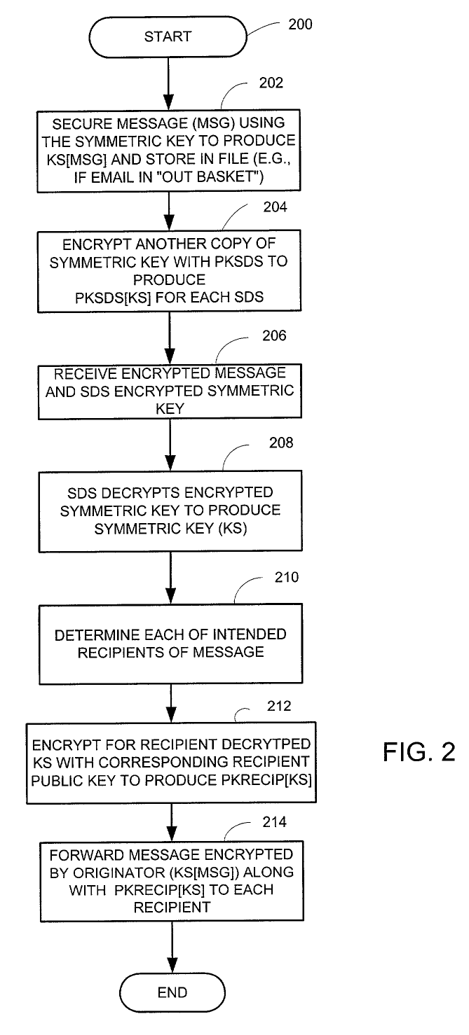

Referring to FIGS. 1 and 2, the operation of the secure communication system 10 will be described. As shown by block 200, the secure distribution server 16a either generates its own asymmetric key pair, such as a public key associated with the secure distribution server (PkSDS) 36 and a corresponding private key associated with the secure distribution server (PrSDS) 38 and the associated public key certificate or may obtain the asymmetric key pair from a suitable certificate issuing authority. When a user of the sender 12 signs up to use the service provided by the secure distribution server 16a, the secure distribution server 16a or other entity provides the public key associated with the secure distribution server (PkSDS) to the sender 12 or the sender pulls the information from a suitable location. As such, the sender 12 has a copy of the PkSDS 36 stored, for example, in a local cache to facilitate off line encryption of the secret key 30 for the secure distribution server or may obtain the public key 36 of the secure distribution server during an on line session if desired. A different secret key may be generated for each message.

As shown in block 202, the sender encrypts the desired information 32, in this example, an e-mail message, using conventional cryptographic techniques by encrypting the information (MSG) 32 with the secret key (KS) 30 (e.g., symmetric key) to produce the encrypted information (KS)[MSG] 34. Where the sender 12 includes, for example, a browser or other suitable application, the sender 12 also stores the encrypted information 34 to a local file such as the “out basket” of an e-mail program and as such stores a copy of the encrypted information 34 locally for later decryption by the sender 12 if desired. The sender 12 also generates the secret key that is used to generate the encrypted information.

As shown in block 204, the method includes the sender 12 encrypting the secret key 30 with a public key associated with the secure distribution server 16a, namely PkSDS 36 to produce an encrypted secret key PkSDS[KS] 40. This may be done for each secure distribution server 16a-16n or for any subset of such secure distribution servers. If desired, the sender also encrypts the secret key 30 with its own public key (PkSEND) and stores the sender encrypted secret key PkSEND[KS] 44 for later use to decrypt the secure information stored in the “out basket” as described above.

In this example, since the encrypted information 34 is an e-mail message, the recipients are designated as part of the message. However, where non-email information is sent, the intended recipients 14a-14n may be designated in any suitable manner. Once the sender generates the encrypted information 34 and the encrypted secret key 40, the sender 12 sends the encrypted information 34 and the encrypted secret key 40 to the secure distribution server 16a. Where more than one secure distribution server is used by the sender in the system, the sender encrypts the secret key 30 using a public key for each of a plurality of secure distribution servers to produce a plurality of secure distribution server-specific encrypted secret keys. The sender may for example encrypt for each of the multiple SDS's or any subset of those servers, including only a single SDS. Each of the secure distribution servers or other entities are then sent their corresponding secure distribution server-specific encrypted secret keys along with the encrypted information 34.

As noted above, if desired, the secret key 30 may be encrypted by the sending device 12 with a public key associated with the sending device, or the user of the sender, to generate PkSEND (KS) 44. If desired, the sender 12 may also digitally sign the information 32 using a private signing key associated with the sending device 12, or the user of the sender. Accordingly, the SDS 16a or a recipient 14a-14n can also perform signature verification using a corresponding public verification key associated with the sender 12, or user of the sender, using conventional digital signature verification techniques.

As shown in block 206, the secure distribution server 16a receives the encrypted information 34 from the sender 12 for transmission to a plurality of intended recipients 14a-14n. The secure distribution server 16a also receives the encrypted secret key 40 that was encrypted using the public key 36 associated with the secure distribution server. As such, the sender 12 need only encrypt the secret key 30 for the secure distribution server and need not encrypt the secret key for any of the intended recipients.

As shown in block 208, the secure distribution server 16a decrypts the encrypted secret key 40, such as using decryptor 24, to produce a decrypted secret key 30. As shown in block 210, the secure distribution server analyzes recipient identification data (e.g., email addresses, etc.) associated with the encrypted information 34 to determine each of the intended recipients, such as by looking at the recipient ID or any other suitable information. The recipient identification data may or may not be encrypted.

As shown in block 212, the method includes encrypting by, for example, the secure distribution server using the encryptor 28, the decrypted secret key 30 with a corresponding public key 52 associated with at least one intended recipient to produce at least one recipient-specific secure secret key. In this example, the decrypted secret key 30 is encrypted with a corresponding public key 52 associated with each of the plurality of intended recipients 14a through 14n to produce a plurality of recipient-specific secure secret keys 54. This may be done by using the decrypted secret key 30 as an input to an encryption algorithm that also receives the corresponding public keys 52a-52n of the recipients (or a public key associated with a group of recipients). The secure distribution server 16a may obtain the public keys for each intended recipient (including a group of recipients) through the certificate source 20 by obtaining the corresponding public keys from, for example, a certificate retrieval and validation service, an LDAP look up, a certificate directory look up, or any other suitable public key accessing technique. In the case of personal trust certificates, the sender sends personal trust certificates to the SDS or the SDS may capture incoming personal trust certificates as they are sent. Also, the SDS may request a recipient or sender to forward the personal trust certificate if it is not able to obtain it from its cache, or any other certificate source.

The encrypting by the SDS results in a plurality of wrapped symmetric keys. The decrypted secret key may be wrapped so that individual wrapped secret keys are generated for each recipient. Recipients may be sent only their respective wrapped key or may be sent the recipient-specific secure secret keys for all (or a subset of) recipients of a message. The encrypting may also include using a public key associated with a group of recipients.

Alternatively, the secure distribution server 16a may generate a copy of the decrypted secret key for each of the plurality of intended recipients (or for one recipient) using a secret key copier, thereby producing a plurality of secret keys each associated with intended recipients and subsequently encrypting copies of the decrypted secret key 30 with a corresponding public key 52a-52n associated with each of the plurality of intended recipients 14a through 14n to produce a plurality of recipient-specific secure secret keys 54a-54n.

As shown in block 214, once the secure distribution server produces the plurality of recipient-specific secure secret keys by encrypting the decrypted secret key using the associated public keys of each of the intended recipients, the secure distribution server 16a forwards, through the transceiver 22, the encrypted information 34, which has not itself been decrypted, and a recipient-specific secure secret key for each corresponding intended recipient. As such, the secure distribution server 16a sends the encrypted information 34 along with the recipient-specific secure secret key 54a to recipient 14a and forwards the encrypted information 34 along with the recipient-specific secure secret key 54n to recipient 14n. Also if desired, the encrypted information and all of the recipient-specific secure secret keys 54a-54n may be sent to all recipients and each recipient may select their own respective recipient-specific secure secret key.

Accordingly, the secure distribution server 16a does not encrypt the encrypted information and the sender 12 need not generate potentially thousands of encrypted secret keys for intended recipients. Since the sender 12 encrypts the encrypted information and sends it to the secure distribution server and since the secure distribution server then forwards the encrypted information to the recipient, the information is encrypted throughout the entire process. Moreover, the sender 12 may have a cryptographic engine that requires less complexity and the sender may require less storage capabilities using the aforedescribed process. Other advantages will be recognized by those having ordinary skill in the art.

It will be recognized that although the decryptor 24 decrypts the received encrypted secret key 40 that was encrypted using the public key associated with the network element to produce the decrypted secret key 30, the decryptor 24 may be located in another device. Therefore, as described herein, the network element may include one or more servers if desired. In addition, the secret key copier 26 that generates a copy of the decrypted secret key for each of the plurality of intended recipients associated with the encrypted information may also be in another device. However, it is desirable to include the decryptor, secret key copier and encryptor in one unit for security purposes and also to provide less complex signaling among differing units. As noted, the transceiver 22 forwards the encrypted information 34 sent by the sender 12 and at least one recipient-specific secure secret key 54 for a corresponding intended recipient.

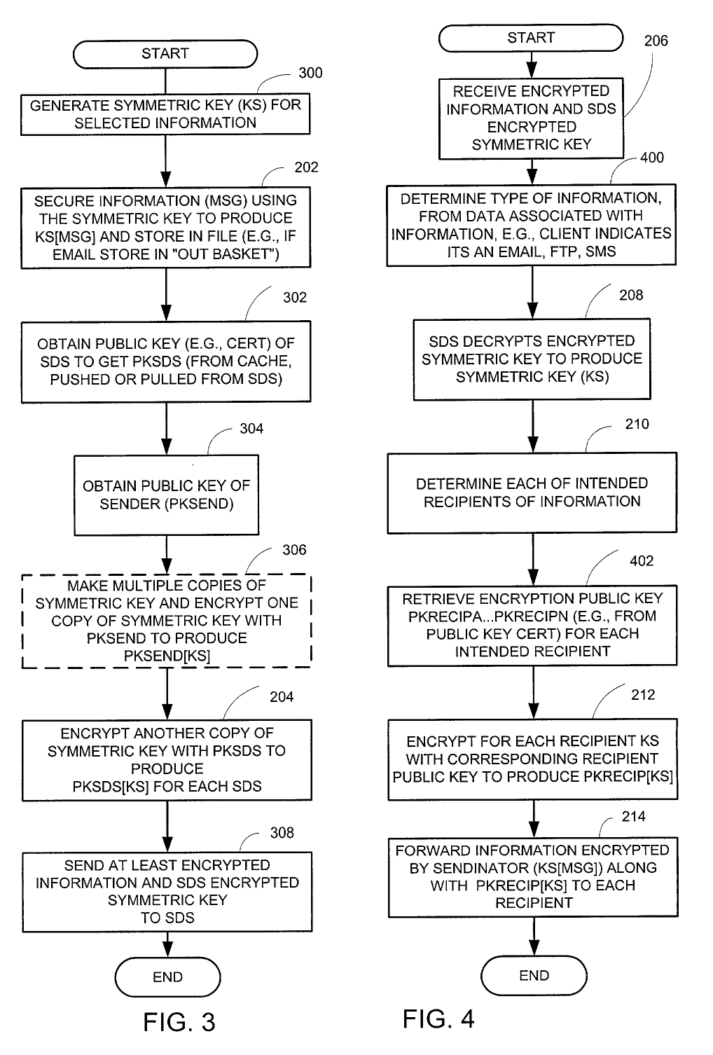

Referring to FIG. 3, a method for securing information is shown from the perspective of the sender 12. As shown in block 300, the sender generates the symmetric key (KS) 30 on a per message or per session basis, for example, as shown in block 300 using conventional cryptographic techniques. The sender 12 then secures the information as previously described with respect to block 202 (FIG. 2). As shown in block 302, the sender 12 obtains the public key associated with the secure distribution server 16a or multiple SDS's, which as noted above, may be from a local cache, may be pushed or pulled from the secure distribution server or from any other suitable public key source. As shown in block 304, the sender 12 also obtains a copy of its own public key. As shown in block 306, if desired, the sender may encrypt the secret (e.g., symmetric) key with the public key associated with the sending device, or user of the sender, to produce PkSEND 44.

As shown in block 308, the sender 12 then sends the encrypted information 34 and the secure distribution server encrypted symmetric key 40 to the secure distribution server 16a or multiple SDS's. If desired, the sender 12 may also send the encrypted symmetric key 44 that is encrypted using the sender's public key. This may be desirable to allow for the recovery of the message later if it was archived.

FIG. 4 illustrates one example of a method for securing information from the perspective of the secure distribution server 16a. As shown, once the encrypted information 34 and the encrypted secret key 40 for the secure distribution server has been received, the method includes determining the type of information that was sent, the list of intended recipients and the information transport protocol over which the encrypted information is to be sent. For example, the secure distribution server 16a may determine whether the encrypted information 34 is an encrypted e-mail, FTP information, SMS or other form of information as indicated by designation information in the sent message or separately as desired. If desired, the sender may also program the SDS to indicate where and how to send the information, in which case the recipient information and the information transport protocol and the recipient list need not be sent with the message. This could be sent out of band or in several sequential messages. This is shown in block 400. The method then includes the secure distribution server decrypting its copy of the encrypted symmetric key 34 to produce the symmetric key 30 (i.e., the decrypted secret key) and determining each of the intended recipients 14a-14n of the information to make copies of the symmetric key for each intended recipient. As shown in block 402, the method includes retrieving the encryption public key for each intended recipient from a suitable certificate or multiple certificate sources. This may be done by a certificate retrieval program or other suitable software or hardware as desired. The method then includes the operations as described above.

From a system perspective, the sender may encrypt the information with the secret key to produce the encrypted information 34 and also during an off-line mode may encrypt the secret key with the public key associated with the secure distribution server(s) to generate the encrypted secret key 40 or keys. Subsequently during an on-line session, the client may then send the encrypted information 34 and any encrypted secret key(s) 40 to the secure distribution server(s) to facilitate a more flexible secure information communication approach.

As another advantage, only a small header, in the case of e-mails, or other information sent with header information, is employed since the sender only encrypts the secret key for itself (if desired) and for a small number of secure distribution servers. This can be very desirable for hand held devices or other processing limited devices or devices that connect to the network using a limited bandwidth link.

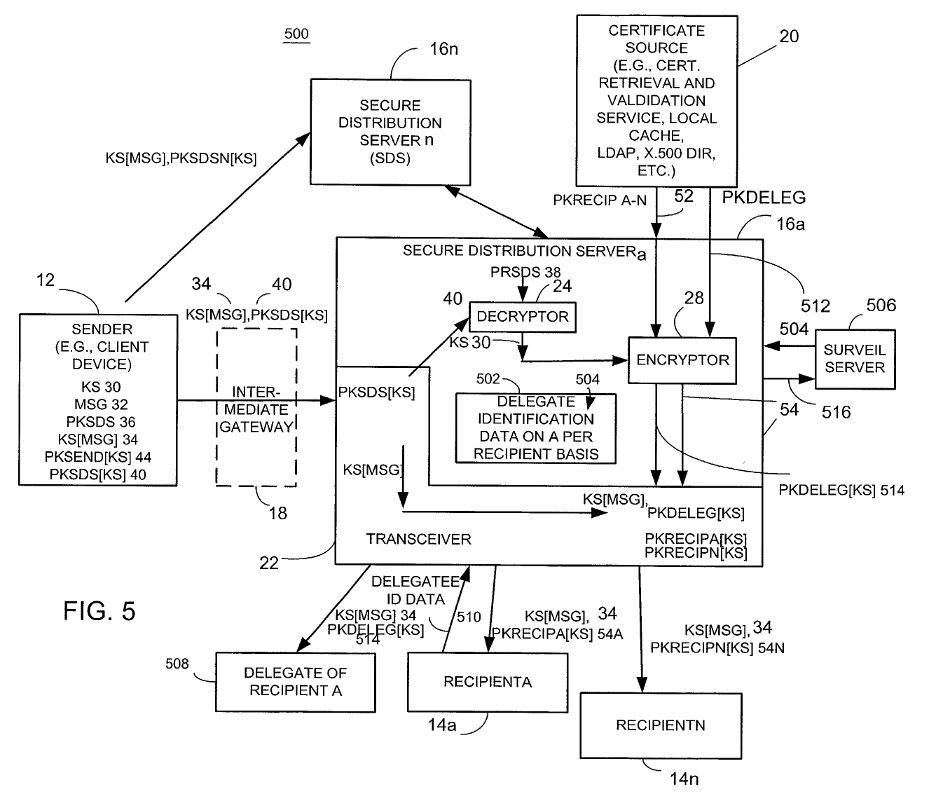

FIG. 5 illustrates an alternative embodiment of a secure communication system 500 wherein the secure distribution server 16a includes memory 502 that stores delegate identification data 504 which identifies delegates of one or more recipients, senders or other entities. Also if desired, the secure communication system 500 may include a surveillance server 506 which also may provide delegate identification data 504 to the secure distribution server 16a which designates the surveillance server 506 as a delegate for one or more recipients 14a-14n, senders or other entities. In this example, recipient 14a has identified delegate 508 as being a delegate for receiving e-mails that are sent to recipient 14a. It will be recognized, however, that each of the multiple recipients may have one or more delegates as desired. In addition, although the secure communication system 500 is shown to include the operations of the secure distribution server of FIG. 1, it will be recognized that if desired, the secure distribution server 16a may be designed to offer only the delegate secure communication operations as described below or may provide both secure communication with recipients and senders with their corresponding delegates.

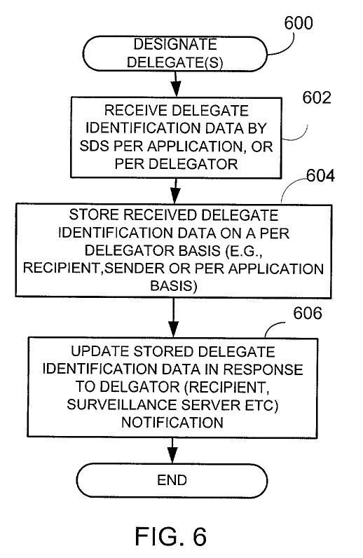

FIG. 6 is a flow chart illustrating a method for securing information as carried out as part of a set up procedure or an ongoing process between recipients and senders or any other entities and the secure distribution server 16a. As shown in block 600, the method includes each recipient, sender or other entity designating one or more delegates. For example, a recipient may establish delegation through an end user delegation interface by clicking GUI buttons or by providing voice commands or any other suitable user interface operations. As is known, the interface may provide a list of some or all of the current delegation relationships for a given recipient, sender or other entity. For example, different delegates may have different privileges. For example, one delegate may be allowed to receive encrypted information sent to a recipient whereas another delegate may be allowed to receive information encrypted by a sender. Also, different delegate parameters may be defined, as known in the art, such as the length of time that the delegate relationship is valid, the identity of the delegator and corresponding delegate, the type of delegate relationship, and any keys or certificates required in a secure messaging environment. It will be recognized that any other suitable delegate information may also be entered through a suitable user interface. Also, the delegator may select to modify or delete an existing relationship. Once the delegation parameters have been identified, the delegator sends the delegate identification data 504 via a message 510 to the secure distribution server 16a. The secure distribution server then stores the received delegate identification data 504 in memory 502 on a per delegator and per software application basis. This is shown by blocks 602 and 604.

Delegate identification data 504 may include, but is not limited to, the email address of a delegate, a URL, a name of a person, or any other suitable identification information that allows the secure distribution server at least to obtain (directly or indirectly) a requisite public key or public key certificate associated with a delegate as further described below.

As shown in block 606, during communications, if a delegator decides to update or change delegate relationships, any updates are signed (or unsigned if desired) and sent by the delegator to the secure distribution server. The secure distribution server 16a then verifies the delegator signature and if valid, updates the stored delegate identification data 504 accordingly in response to the delegator notification.

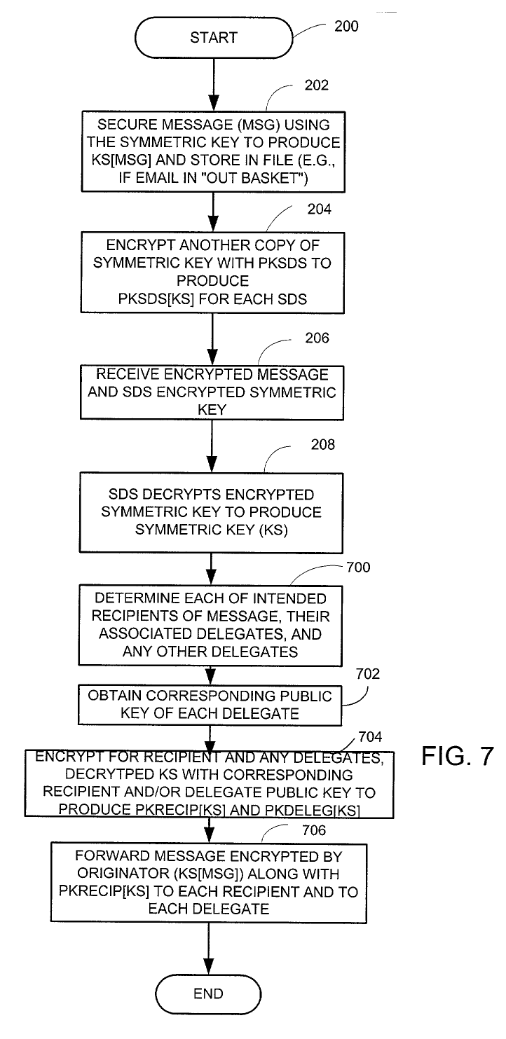

FIG. 7 illustrates an example of a method for securing information that includes some similar steps as previously described. Accordingly, the SDS receives encrypted information from a sender for transmission to at least one intended recipient along with an encrypted secret key 40 that was encrypted using a public key associated with the secure distribution server. This is shown in block 202. The secure distribution server decrypts the encrypted secret key 40 to produce a decrypted secret key 30 as previously described. The method further includes, as shown in block 700, the secure distribution server determining each of the intended recipients of the message and determining if a delegate is designated for one of the intended recipients. For example, in the case of an e-mail message, the intended recipient information is compared with recipient identification data stored as part of the delegate identification data 504. For example, data representing recipient 14a previously sent by the recipient and stored in memory 502 is compared with the intended recipient identification data in the e-mail message. If there is a match such as matching recipient e-mail addresses, or any other suitable identifying information, indicating that the intended recipient has designated a delegate, the delegate identification data 504 is analyzed to obtain a corresponding public key of the designated delegate as shown in block 702.

For example, an e-mail address of a delegate or any other identifying information may be used by the secure distribution server to search for a public key certificate from the certificate source 200. This may also include, for example, checking a local cache, searching any suitable LDAP directory, employing a third-party certificate retrieval service, or any other suitable method to obtain a corresponding public key associated with the delegate of a specific recipient. Accordingly, a corresponding public key of a delegate 512 is retrieved and used by encryptor 28 to encrypt the decrypted secret key 30 to produce a delegate-specific secure secret key PKDELEG[KS] 514. This is shown, for example, in block 704. As such, the secure distribution server 16a may encrypt for each recipient and/or each delegate of each recipient (including system designated delegates, a corresponding public key to produce the respective delegate-specific secure secret keys and/or recipient-specific secure secret keys. As shown in block 706, the method includes forwarding, for the delegate 508, the encrypted information 34 sent by the sender and the delegate-specific secure secret key 514. The delegate 508 may then use its corresponding private key to obtain the secret key 30 and use the resulting secret key 30 to decrypt the encrypted information. Accordingly, delegation is facilitated without the requirement of sharing private keys among recipients or with the secure distribution server. Other advantages will be recognized by those of ordinary skill in the art.

In summary, the secure distribution server 16a receives the delegate identification data 504 associated with the intended recipient, such as sent by a recipient, or for senders as sent by a sender, and stores the delegate identification data 504 in memory 502. When an encrypted message is sent for the intended recipient, the secure distribution server obtains the requisite public key associated with delegates identified by the delegate identification data 504 and creates (or retrieves an already created) the delegate-specific secure secret key.

In a similar way as set forth above, the secure distribution server may also determine if there are assigned delegates for the sender. For example, a party may want to delegate to see email that they have sent to know which messages have been answered. Also from a surveillance standpoint, it may be the activity of the sender that is monitored.

The secure surveillance server 506 or other suitable third party may also send the delegate identification data 504 to the secure distribution server 16a that stores the delegate identification data for a plurality of intended recipients and/or senders. For example, the secure distribution server 16a may store delegate identification data 504 for a plurality of different recipients and for differing applications executed by those various recipients. The third party or surveillance server 506 is not considered to be a recipient in this example since it is not identified by the sender. Accordingly, the delegate identification data 504 sent by the third party surveillance server 506 may include priority data which notifies the secure distribution server to always forward encrypted information designated for a specific recipient to the surveillance server as a delegate. In this way the recipient designated by the surveillance server is not aware that a third party is receiving the encrypted information.

For surveillance delegation, an internal administrator may use a delegation interface that provides a list of some or all current delegation relationships. The administrator may add or choose to modify existing delegation relationships as desired, as known in the art. The surveillance server 506 sends a recipient ID chosen by the administrator that can be used to be compared with recipient identification data sent by the sender. Also, the surveillance server 506 may send a sender ID that can be used to be compared with sender identification data stored by the network element. The surveillance server sends, as delegate ID data, the surveillance server ID as part of the delegate ID data so that a public key of the surveillance server is used to encrypt the secret key 30. The secret key encrypted using the public key of the surveillance server is sent to the surveillance server as shown by line 516 (see FIG. 5).

The delegation identification data 504 may represent as noted, a delegated application such as another e-mail program and/or a delegated device using an application ID or device ID, for example. Any other suitable identification data may also be used if desired. Hence, the above delegation methods and apparatus provide a relatively simple scheme which is relatively easy to deploy and provides secure messaging with fewer connections and fewer lookups for a sender. Also as noted, the delegation methods and apparatus do not require the sharing of private keys between a delegate and the delegator.

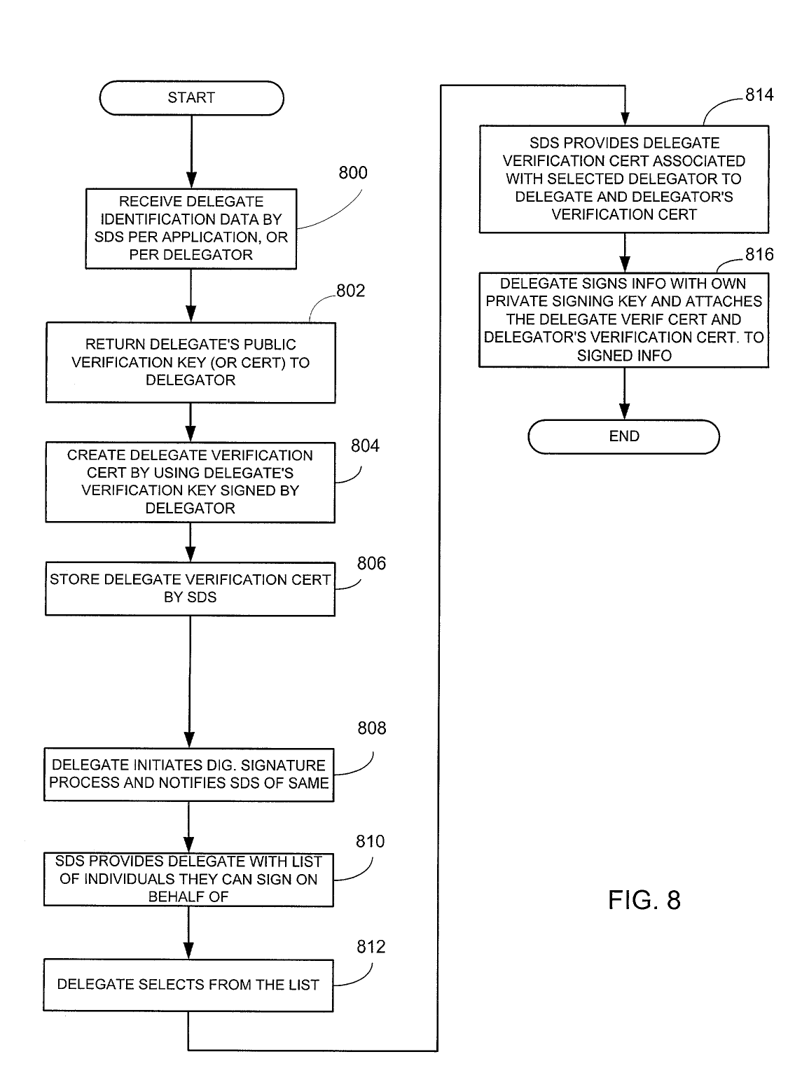

FIG. 8 is a flow chart illustrating a method of securing information by providing digital signature delegation. As shown in block 800, the method includes receiving the delegate identification data 504 by the SDS on a per application or per delegator basis. In this example, a delegator is considered to be an application or unit that allows delegation of digital signing privileges on behalf of the delegator by another software application or device. As such, the delegate ID data indicates that the delegation type is for signing (as opposed to encryption). As shown in block 802, the secure distribution server 16a, upon analyzing the delegate identification data 504, determines the delegate and returns the delegate's public verification key or verification certificate to the delegator. This is done using the similar processes described above with respect to obtaining the requisite public key information from a suitable certificate source but in this case a public verification key is obtained as opposed to a public encryption key. As shown in block 804, the method includes the delegator, or other suitable entity, creating a certificate, referred to as a delegate verification certificate, which is created by using the delegate's verification key signed by the delegator. The delegator sends back the generated delegate verification certificate signed by the delegator back to the SDS. As shown in block 806, the method includes storing the delegate verification certificate by the secure distribution server.

As shown in block 808, the delegate initiates the digital signature process by, for example, activating a cryptographic program. The delegate then notifies the secure distribution server that the digital signature process has begun. As shown in block 810, in response, the secure distribution server provides the delegate with a list of individuals that the delegate can sign on behalf of. This list was provided a priori by the delegator as part of the delegate identification data.

This may be provided, for example, through a GUI interface or any other suitable interface. As shown in block 812, the method includes the delegate selecting a delegator from the list. As shown in block 814, the method includes the secure distribution server, providing the delegate verification certificate associated with the selected delegator to the delegate along with the delegator's verification certificate. Accordingly, the SDS obtains the delegator's verification certificate from the suitable certificate source along with the created delegate verification certificate created by, for example, the delegator.

As shown in block 816, the delegate signs desired information with its own private signing key and attaches the delegate verification certificate and the delegator's verification certificate to the signed information. The signed information is then sent by the delegate to the intended recipient via the SDS. In this way, the recipient can build a chain back to a trusted root as well as have a special certificate within the path that indicates that the delegator gave permission to the delegate to sign on their behalf.

With this delegated signing apparatus and method, no private signing keys need to be exchanged between a delegate and delegator.

It will be recognized that although steps have been described with reference to a particular order, any suitable order of operations may be carried out. Moreover, the operations as noted may be carried out by any suitable devices as desired.

It should be understood that the implementation of other variations and modifications of the invention in its various aspects will be apparent to those of ordinary skill in the art, and that the invention is not limited by the specific embodiments described. It is therefore contemplated to cover by the present invention, any and all modifications, variations, or equivalents that fall within the spirit and scope of the basic underlying principles disclosed and claimed herein.

What is claimed is:

1. A method for securing information comprising:
receiving encrypted information from a sender for transmission to at least one intended recipient and an encrypted secret key encrypted using a public key associated with a network element;
decrypting the encrypted secret key to produce a decrypted secret key;
determining if a delegate is designated for at least one of the intended recipient and a sender;
obtaining a corresponding public key of the delegate;
encrypting the decrypted secret key for the delegate using a public key corresponding to the delegate to produce a delegate-specific secure secret key; and
forwarding, for the delegate, the encrypted information sent by the sender and the delegate-specific secure secret key.

2. The method of claim 1 including receiving delegate identification data associated with at least one of the intended recipient and sender, storing the delegate identification data and wherein the step of obtaining the corresponding public key of the delegate is based on the stored delegate identification data.

3. The method of claim 1 including sending, by at least one of the intended recipient and a sender, the delegate identification data to a secure distribution server that stores delegate identification for at least one of a plurality of intended recipients and sender.

4. The method of claim 1 including sending, by a third party, delegate identification data to a secure distribution server that stores delegate identification for at least one of a plurality of intended recipients and a plurality of senders.

5. The method of claim 1 including the step of storing for at least one of a plurality of intended recipients and senders, delegate identification data wherein the delegate identification data represents at least one of: a delegated application and a delegated device.

6. The method of claim 1 wherein each of the steps of receiving, decrypting, determining, obtaining, encrypting and forwarding are performed by the secure distribution server.

7. A method for securing information comprising:
receiving, by a secure distribution server, encrypted information from a sender for transmission to at least one intended recipient and an encrypted secret key encrypted using a public key associated with the secure distribution server;
decrypting the encrypted secret key to produce a decrypted secret key;
obtaining a corresponding public key of the at least one intended recipient;
encrypting the decrypted secret key for the at least one intended recipient using a corresponding public key to produce at least one recipient-specific secure secret key;
determining if a delegate is designated for at least one of the intended recipient and a sender;
obtaining a corresponding public key of the delegate;
encrypting the decrypted secret key for the delegate using a public key corresponding to the delegate to produce a delegate-specific secure secret key;
forwarding the encrypted information sent by the sender and at least one recipient-specific secure secret key for the at least one corresponding intended recipient; and
forwarding the encrypted information sent by the sender and the delegate-specific secure secret key for the delegate.

8. The method of claim 7 including receiving delegate identification data associated with the intended recipient or at least one sender, storing the delegate identification data and wherein the step of obtaining the corresponding public key of the delegate is based on the stored delegate identification data.

9. The method of claim 7 including sending, by the intended recipient, the delegate identification data to a secure distribution server that stores delegate identification for a plurality of intended recipients or a plurality of senders.

10. The method of claim 7 including sending, by a third party, the delegate identification data to a secure distribution server that stores delegate identification data for at least one of a plurality of intended recipients and a plurality of senders.

11. The method of claim 7 including the step of storing for a plurality of intended recipients, delegate identification data wherein the delegate identification data represents at least one of: a delegated application and a delegated device.

12. The method of claim 7 including determining a plurality of intended recipients and retrieving corresponding public keys of the plurality of intended recipients for encrypting the secret key and for each of the plurality of intended recipients, also retrieving corresponding public keys associated with delegates.

13. The method of claim 7 wherein encrypting the secret key includes encrypting the secret key using a public key for each of a plurality of secure distribution servers to produce a plurality of secure distribution server specific encrypted secret keys.

14. The method of claim 7 including storing the encrypted information in an encrypted form locally on the device that performed the step of encrypting information with the secret key.

15. The method of claim 7 including the step of determining, by the secure distribution server, if the encrypted information needs to be sent to other entities, if so, encrypting the decrypted secret key using a public key associated with each of the additional entities.

16. The method of claim 7 wherein obtaining the corresponding public key of the delegate includes obtaining the corresponding public key from at least one of: a certificate retrieval and validation service, a local cache, an LDAP lookup and a certificate directory lookup.

17. A network element comprising:
means for decrypting a received encrypted secret key encrypted using a public key associated with the network element to produce a decrypted secret key;
means, operatively coupled to the means for decrypting, for obtaining a corresponding public key of at least one delegate associated with at least one of an intended recipient and a sender;
means, operatively coupled to the means for obtaining, for encrypting the decrypted secret key for the at least one delegate using a corresponding public key to produce a delegate-specific secure secret key; and
means for forwarding the encrypted information sent by a sender and at least one delegate-specific secure secret key for at least one corresponding delegate associated with the intended recipient or the sender.

18. The network element of claim 17 including memory, operably coupled to the means for obtaining, that stores the delegate identification data and wherein the means for obtaining uses the stored delegate identification data to obtain the corresponding public key of the delegate.

19. The network element of claim 18 wherein the memory stores delegate identification for at least one of a plurality of intended recipients and a plurality of senders.

20. The network element of claim 17 wherein the delegate identification data represents at least one of: a delegated application and a delegated device.

21. The network element of claim 18 wherein the means for obtaining retrieves corresponding public keys of a plurality of delegates associated with at least one of a sender and a plurality of intended recipients, for encrypting the decrypted secret key from at least one of: a certificate retrieval and validation service, an LDAP lookup, a local cache and a certificate directory lookup.

22. A storage medium comprising:
memory containing executable instructions that when read by one or more processing devices, causes the one or more processing devices to:
receive encrypted information from a sender for transmission to at least one intended recipient and an encrypted secret key encrypted using a public key associated with a network element;
decrypt the encrypted secret key to produce a decrypted secret key;
determine if a delegate is designated for at least one of the intended recipient and a sender;
obtain a corresponding public key of the delegate;
encrypt the decrypted secret key for the delegate using a public key corresponding to the delegate to produce a delegate-specific secure secret key; and
forward, for the delegate, the encrypted information sent by the sender and the delegate-specific secure secret key.

23. The storage medium of claim 22 including memory containing executable instructions that when read by the one or more processing devices causes the one or more processing devices to:
receive delegate identification data associated with at least one of the intended recipient and the sender, store the delegate identification data and obtain the corresponding public key of the delegate based on the stored delegate identification data.

24. The storage medium of claim 22 including memory containing executable instructions that when read by the one or more processing devices causes the one or more processing devices to:
send, by at least one of the intended recipient and the sender, the delegate identification data to a secure distribution server that stores delegate identification data for a plurality of intended recipients.

25. The storage medium of claim 22 including memory containing executable instructions that when read by the one or more processing devices causes the one or more processing devices to:
send, by a third party, the delegate identification data to a secure distribution server that stores delegate identification for at least one of a plurality of intended recipients and a plurality of senders.

26. The storage medium of claim 22 including memory containing executable instructions that when read by the one or more processing devices causes the one or more processing devices to:
store for at least one of a plurality of intended recipients and a plurality of senders, delegate identification data wherein the delegate identification data represents at least one of: a delegated application and a delegated device.

27. The storage medium of claim 22 including memory containing executable instructions that when read by the one or more processing devices causes the one or more processing devices to:
determine a plurality of intended recipients and retrieve corresponding public keys of the plurality of intended recipients for encrypting the secret key.

28. The storage medium of claim 22 including memory containing executable instructions that when read by the one or more processing devices causes the one or more processing devices to determine if the encrypted information needs to be sent to other entities, if so, encrypting the decrypted secret key using a public key associated with each of the additional entities.

29. A secure communication system comprising:
at least one sender that encrypts information with a secret key to produce encrypted information, encrypts the secret key with a public key associated with a network element to produce an encrypted secret key, and during an online session, sends the encrypted information and the encrypted secret key to the network element;
at least one intended recipient;
at least one network element, operatively coupled to the sender and to the at least one intended recipient, including:
means for decrypting a received encrypted secret key encrypted using a public key associated with the network element to produce a decrypted secret key;
means, operatively coupled to the means for decrypting, for obtaining a corresponding public key of at least one delegate associated with an intended recipient or a sender;
means, operatively coupled to the means for obtaining, for encrypting the decrypted secret key for the at least one delegate using a corresponding public key to produce a delegate-specific secure secret key; and
means for forwarding the encrypted information sent by a sender and at least one delegate-specific secure secret key for at least one corresponding delegate associated with the intended recipient.

30. The system of claim 29 including memory, operably coupled to the means for obtaining, that stores the delegate identification data and wherein the means for obtaining uses the stored delegate identification data to obtain the corresponding public key of the delegate.

31. The system of claim 30 wherein the memory stores delegate identification data for a plurality of intended recipients or a plurality of senders.
